(19) United States
(12) Patent Application Publication
(10) Pub. No.: US 2002/0120395 A1
(43) Pub. Date: Aug. 29, 2002

(54) On-line navigational system

(76) Inventor: Bruce Smith, Ottawa (CA)

Correspondence Address: MARKS & CLERK, P.O. BOX 957, STATION B, OTTAWA, ON, K1P 5S7, CA

(21) Appl. No.: 10/079,560

(22) Filed: Feb. 22, 2002

Related U.S. Application Data
(60) Provisional application No. 60/270,630, filed on Feb. 23, 2001.

(51) Int. Cl. G01C 21/26

(52) U.S. Cl. 701/208; 701/200

(57) ABSTRACT

This invention relates to computer-based navigational systems wherein a user is able to navigate through a series of hierarchically arranged map images using navigational means such as embedded hyperlink hotspots. Through the navigational system a user is also able to acquire, (on-line, through an intranet, or through the use of a computer program), specific information such as directions, services and activities respecting any location of interest throughout the world.

This invention claims the benefit of U.S. Provisional Application No. 60/270,630 filed Feb. 23, 2001.

### FIELD OF THE INVENTION

This invention relates to a computer-based navigational system in which a user is able to navigate through a hierarchical arrangement of map images and acquire information such as location, services, activities, etc. respecting regions of interest throughout the world.

### BACKGROUND OF THE INVENTION

The ability to ascertain relevant information concerning various locations of the world is invaluable to travellers whether planning a trip for business or for pleasure. Frequently, such trips will take one to locations of the world which are unfamiliar to them. It is also valuable to students of geography or people following current events to be able to locate specific regions or countries of the world through the Internet or an Intranet. It is, of course, well known for people to rely on atlases and other mapping services to find the location of certain regions relative to other regions in the world. In order to do so, however, one must scan through multiple pages of the atlas relying on an index to zero in on the chosen location.

Internet mapping services are, of course, known. Generally, however, such mapping services rely on a text based system for initial navigation. In other words, a user will scan a text menu and then select from the menu the country or region within a country for which a location information is desired. This, of course, assumes that the user has a general knowledge of the chosen location which is not always the case particularly for some obscure or unfamiliar region.

There is, therefore, a need for an online navigational system which starts as a basic premise from a map of the world and then gives a user the opportunity to click on specific regions in a hierarchical fashion until a sub region such as particular community in a city is displayed.

It is also useful for travellers to be able to find out information regarding services activities etc. within a particular location. For example, a traveller may be visiting a city for the first time and would want to know whether there are particular festivals or other celebrations going on during a specific time or the user may wish to know something about restaurants, hotels, hospitals, libraries, museums or other points of interest. Currently, in order to acquire this additional information one must go to other brochures or on-line sites which may or may not contain the current information.

### SUMMARY OF THE INVENTION

The present invention satisfies the above requirements by providing a navigational system which starts from a map of the entire world and which allows a user to select a particular location or region within the world and to obtain more greater location details by clicking on hyperlink hotspots within the map.

As a further refinement of the location service the present invention also allows a user of the navigational system to obtain relevant information regarding a specific location as well as a particular region within a selected city or town.

It is also within the scope of the invention to include information such as photographs showing a selected building or street which would give a potential traveller a better idea of whether the selected building such as a hotel or restaurant is satisfactory to them.

In accordance with a first aspect of the present invention there is provided a computer based communications system for navigating through a hierarchical series of map images comprising: a graphical user interface to display the map images, each map image having embedded navigational means associated with subsets of the map images; and means to activate the navigational means to display selected ones of the subsets of map images. In a preferred embodiment the embedded navigational means are hyperlink hotspots.

In accordance with a second aspect of the present invention there is provided a method of navigating through a hierarchical series of map images via a computer based communications system comprising: displaying the map images on a graphical interface, the map images having embedded navigational means, the navigational means being associated with subsets of the map images; and displaying selected ones of the subsets of map images by activating the navigational means associated with a desired subset. In a preferred embodiment the embedded navigational means are hyperlink hotspots.

In accordance with a further aspect of the present invention there is provided a system for generating location specific information for navigation by a user on a computer-based communications network comprising: a server for storing look up tables including location specific information; means for selectively accessing the look up tables; and means to display the location specific information in response to a request by the user.

### BRIEF DESCRIPTION OF THE DRAWINGS

The invention will now be described in greater detail with reference to the attached drawings wherein;

FIG. 1 is a map of the world with a designated hyper link hotspot area;

FIG. 2 shows the result of a click on the highlighted area of FIG. 2 and showing yet another highlighted area;

FIG. 3 shows the result of selecting the highlighted area of FIG. 2 and FIG. 4 shows the result of clicking on the highlighted are of FIG. 3;

FIG. 5 shows a more detailed view of a selection of a particular city shown in FIG. 4;

FIG. 6 shows the map of FIG. 4 wherein one is able to click on an adjoining region;

FIG. 7 shows the result of clicking on the highlighted region of FIG. 6;

FIG. 8 is a further view of the map of FIG. 4 but showing a menu or list of activities or restaurants etc. which may be selected by a user;

FIG. 9 shows the result of clicking on a restaurant item in the menu which lists a number of possible restaurants of interest;

FIG. 10 allows one to obtain more specific information regarding a restaurant listing by clicking on a link to the web site of a particular restaurant;

FIG. 11 shows the number of potential events associated with each of the listings in the event menu;

FIG. 12 shows the action of a click that would result in the sub categories of the categories of types of restaurants;

FIG. 13 breaks down the restaurants by type;

FIG. 14 shows the result of clicking on a particular category of restaurants;

FIG. 15 allows the user to obtain specific location information regarding the selected restaurant;

FIG. 16 shows by map co-ordinates the location of the selected restaurants of FIG. 15;

FIG. 17 shows the result of inputting a particular search location; and

FIG. 18 shows the search database in which one would enter a particular location or an activity in a particular location.

### DETAILED DESCRIPTION OF THE INVENTION

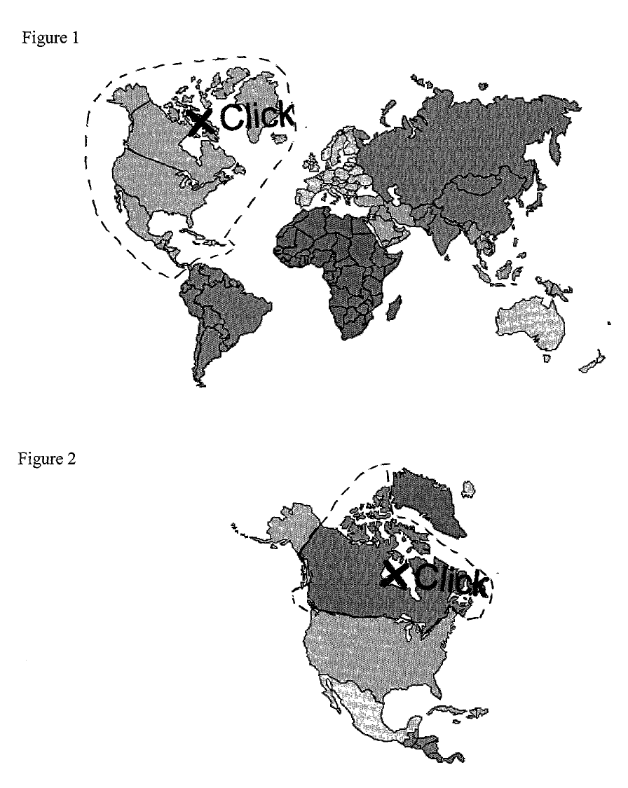

The invention will now be described in greater detail with reference to the accompanying figures. As indicated previously FIG. 1 represents a map of the world which is the view a user would receive on initialization. If a user wishes to locate a specific region or city within the world they can either click on a region as shown in FIG. 1 or, through a search engine enter the city name or location and as a result of a enter command the selected region will be highlighted. This service is particularly useful when the user may not know exactly where the region of interest is located. This is also valuable in countries such as, for example, the United States where Alaska or Hawaii are part of the country but are not located within the normally accepted boundaries of the country. This is also useful in isolating the states, provinces etc. in countries such as the United States, Canada or Australia.

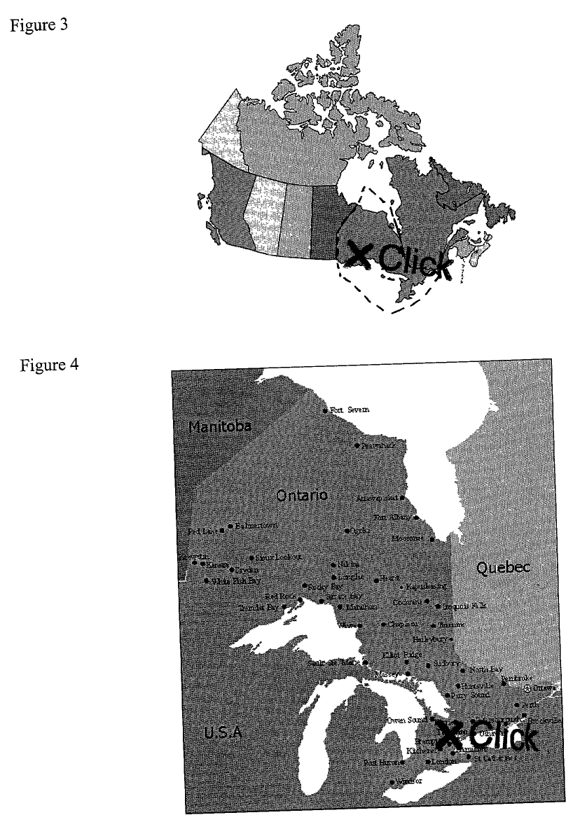

When the selected region is highlighted as in FIG. 1 a click as by a single mouse click of a typical mouse or other means for implementing a command the map shown in FIG. 2 will be displayed to the user. This shows the entire region as selected in FIG. 1. If, then, one clicks on the highlighted region of FIG. 2 the server will produce an enlarged map of the selected region. As shown in FIG. 3 this will present a map of Canada. It is then possible to scan across the entire map until hyperlink hotspots are located and by clicking on one of the hotspots a particular region of the country is displayed. As shown in FIG. 4 this displays a map of the province of Ontario identifying all major centers.

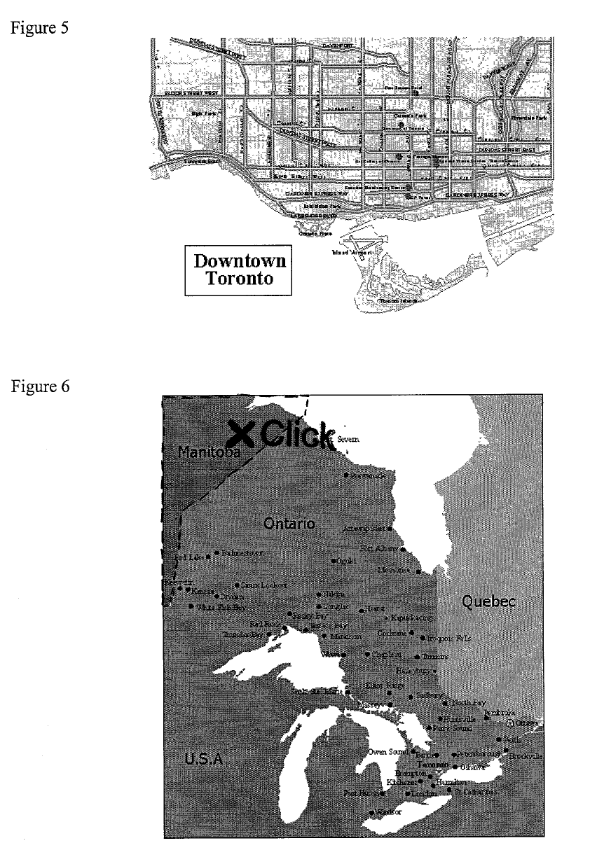

By clicking on any one of the hyperlink hotspots within the province one is able to display a map of that region. In this case the city of Toronto is selected and in FIG. 5 a map of the downtown core is presented.

Thus, by navigating through FIGS. 1 to 5 one is able to move from a map of the world to a detailed map of a particular location within the world. This is intended as an example only and one would be able to obtain the same type of resolution if one wanted to view, for example, the downtown core of Sydney Australia.

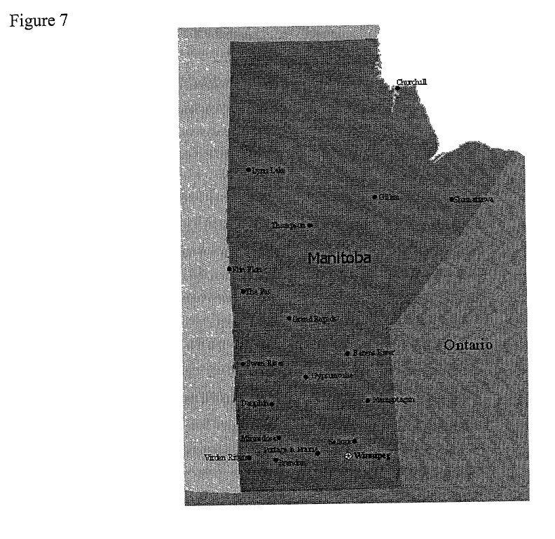

As shown in FIG. 6 the map of Ontario also provides the user the opportunity to click on adjoining rejoins such as Manitoba, Quebec, USA and by clicking on the designated hyperlink hotspot that particular region will then be displayed. FIG. 7 shows the result of clicking on the province of Manitoba.

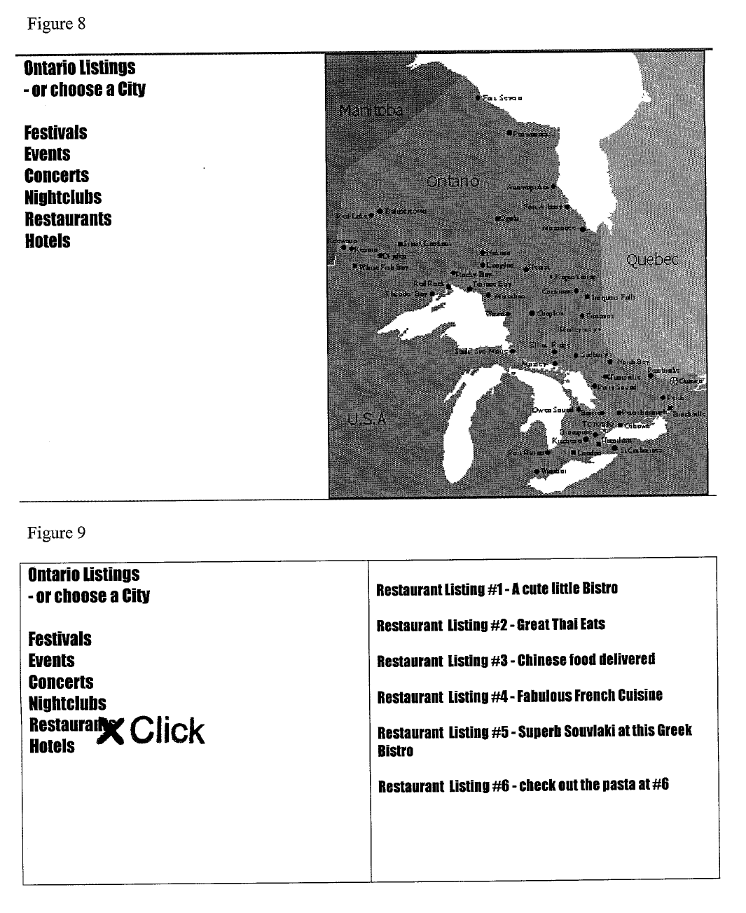

Having located a specific center or city within a selected country within the world it is often very useful to be able to learn more about that city or region. As shown in FIG. 8 if one selects Ontario as a major region one can learn of various events such as festivals, concerts or sites within the city such as night clubs, restaurants, hotels, museums, hospitals etc. In this way if one wanted to learn of a chain of restaurants one could chose the restaurant name and then find locations in which that chain has restaurants. This is also possible for hotels. For example, someone may get a discount from a particular hotel chain and they will want to know in advance whether that chain is in a selected city. A trip can be planned around this information.

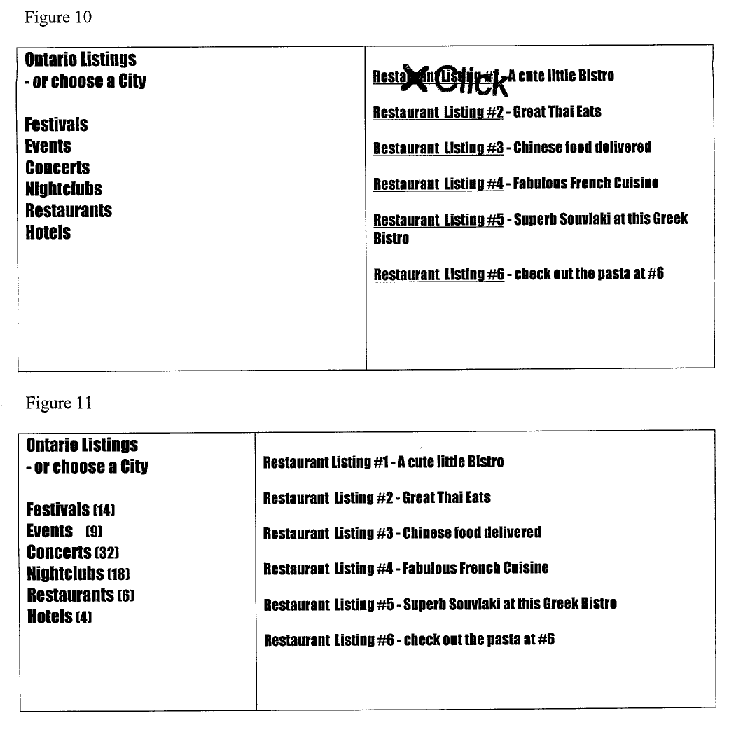

As shown in FIG. 9 the navigational system also allows one to present a list of one or more items from the menu. In this case if one clicks on the menu item “restaurant” a list of potential restaurants are displayed. As shown in FIG. 10 the restaurant information may include minimal background information but allow a user to go directly to the web site of that particular restaurant in order to garner additional relevant information.

The information that is presented to the user may also include the number of events, festivals, etc. that are occurring during the time of interest in a selected location. The list may also identify the number of night club restaurants, hotels etc. that are within the chosen city. As shown in FIG. 11 the numbers are given in brackets following the item in the menu.

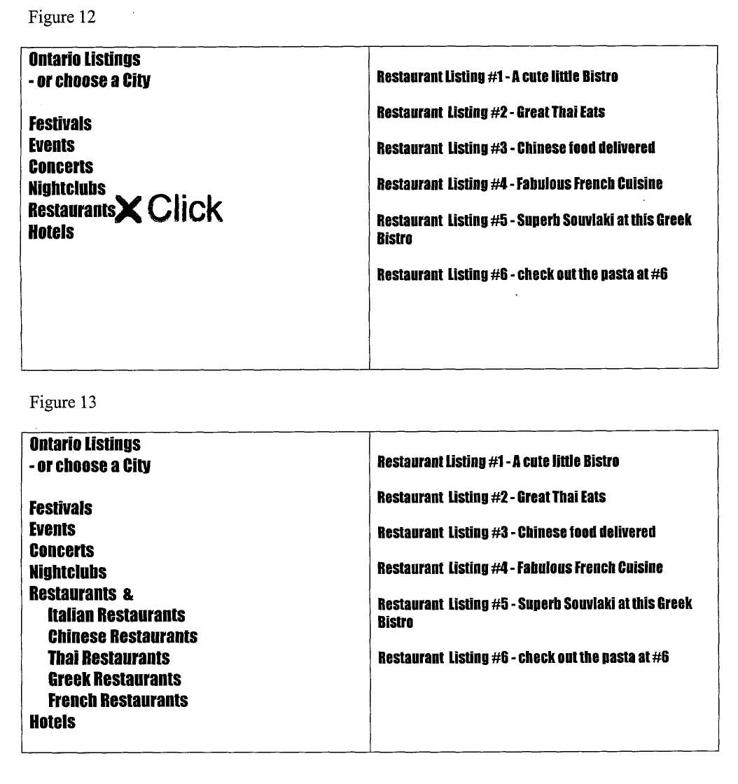

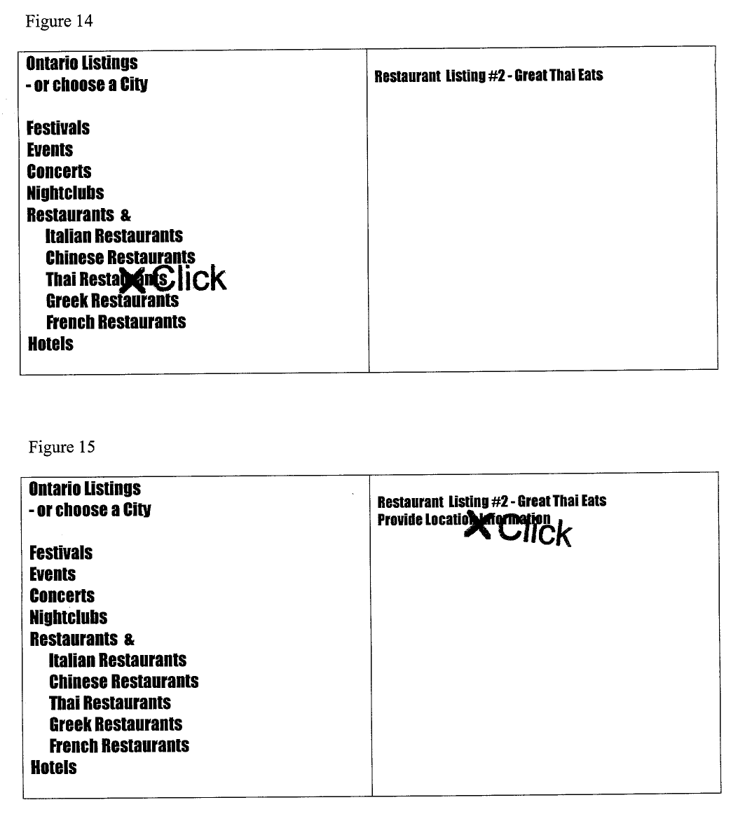

FIG. 12 again shows listings for a chosen city in which information regarding a menu event listing is provided. Thus by clicking on restaurants of FIG. 12 the user is given an opportunity to select a category of restaurant within the broad restaurant field. Thus a user can select, for example, a Thai restaurant and be presented with all of the Thai restaurants that are within the chosen city. This of course is just one example as it would be possible to click on night clubs and be given a list of all of the night clubs within the city and to provide information as to the type of entertainment that is provided during a chosen time frame.

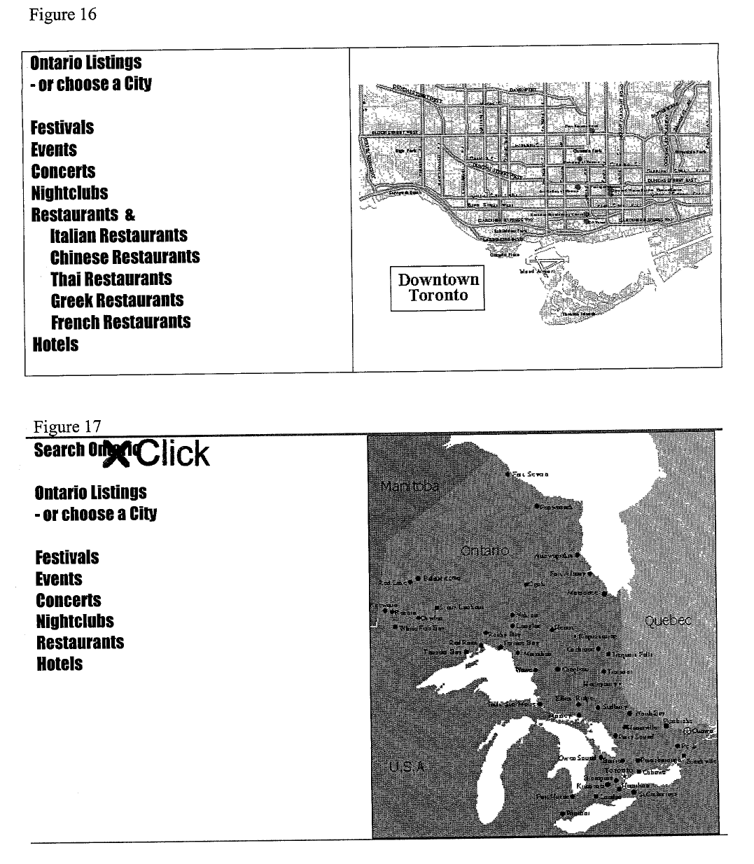

As shown in FIG. 15 the selection of a restaurant can also provide the user aim with an opportunity to obtain location information. The location information can be simply street name and number or, as shown in FIG. 16, a map of the region with the location of the restaurant highlighted or otherwise marked to show the user exactly where the restaurant is relative to other points of interest.

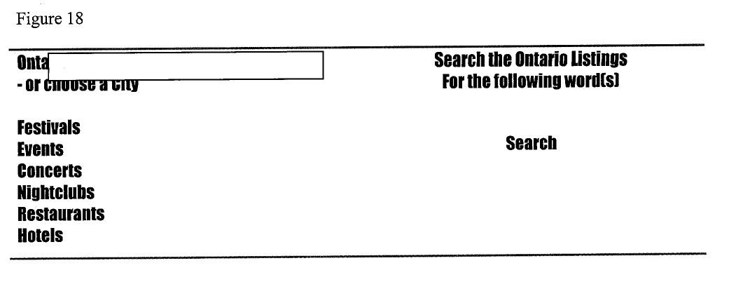

As a further option of the navigational system, FIGS. 17 and 18 give an example of the previously discussed embodiment where one would search within a location for activities of interest. For example if one selected Ontario as the region to be searched the user is given an opportunity to input particular key words that would define the type of event etc. that is of interest.

It is to be understood that the relevant, location specific data would be retained and stored in a server operated by a website such as heretonight.com. The information would be gathered by contacting potential members to make them aware of the service and those members or institutions would provide information regarding time and place of certain events as well as services that could be made available to a potential user. Obviously, if someone came upon the site and realized that it could offer them a valuable service they would contact the web site and in this way permit entry of their information into the data base maintained by the website.

It is anticipated that interested parties would become members and that some fee would be generated through the membership. It is also anticipated that advertising banners could be included in the various map arrangements and that additional revenues would be generated through advertisement.

As indicated previously it is contemplated that not only would the service provide textual information regarding particular cites but that there might also be provided photographs or other pictorial information that would give to the user additional valuable information regarding a cited interest.

As noted above hyperlink hotspots are situated throughout the image and the well known method for allowing a user to click on various parts of an image to navigate to different web pages are used.

As indicated above the most common application for the present invention is by way of the well known world wide web. It is, of course, possible that the information could be made available to a more limited audience through the use of a private Intranet particularly if it is desirable to keep certain information out of the public purview.

It is also contemplated that the information could be made available in other forms such as a CD although it would obviously be necessary to provide periodic updates of information.

Although particular embodiments of the invention have been described and illustrated it will be apparent to one skilled in the art that numerous changes or variations to the basic concept can be introduced. It is to be understood, however, that such changes will fall within the full scope of the invention as defined in the appended claims.

I claim:

1. A computer based communications system for navigating through a hierarchical series of map images comprising:
a graphical user interface to display said map images, each map image having embedded navigational means associated with subsets of said map images; and
means to activate said navigational means to display selected ones of said subsets of map images.

2. A computer based communications system for navigating through a hierarchical series of map images as defined in claim 1 wherein said navigational means is a computer scripting language such as javascript.

3. A computer based communications system for navigating through a hierarchical series of map images as defined in claim 1 wherein said navigational means is a computer scripting language such as VB script.

4. A computer based communications system for navigating through a hierarchical series of map images wherein said navigational means are hyperlink hotspots.

5. The computer based communication system for navigating through as series of map images as defined in claim 1 wherein a first of said map images is a world map.

6. The computer based communications system for navigating through as series of map images as defined in claim 4 wherein said subsets of said map images are regions of said world map, said subsets having hyperlink hotspots associated with further subsets of said map images.

7. The computer based communications system for navigating through as series of map images as defined in claim 1 implemented via the Internet.

8. The computer based communications system for navigating through as series of map images as defined in claim 4 wherein said means to activate said hyperlink hotspots is a mouse click.

9. A method of navigating through a hierarchical series of map images via a computer based communications system comprising:
displaying said map images on a graphical interface, said map images having embedded navigational means, said navigational means being associated with subsets of said map images; and
displaying selected ones of said subsets of map images by activating the navigational means associated with a desired subset.

10. The method as defined in claim 9 wherein said embedded navigational means are hyperlink hotspots.

11. The method as defined in claim 10 wherein said hyperlink hotspots are displayed on said subset to highlight a section of said map image for which a higher scale map image is available.

12. The method as defined in claim 10 wherein said embedded hyperlink hotspots are activated to display a map image having a higher level of detail through a mouse click.

13. The method as defined in claim 10 wherein location specific information is also obtained relative to said map images, said location specific information being retrieved from a central server in response to user generated request.

14. The method as defined in claim 10 wherein said location specific information is provided to said central servers by subscribers.

15. A system for generating location specific information for navigation by a user on a computer-based communications network comprising:
a server for storing look up tables including location specific information;
means for selectively accessing said look up tables; and
means to display said location specific information in response to a request by said user.

16. The system for generating location specific information for navigation by a user on a computer-based communications network as defined in claim 15 wherein said location specific information includes a menu of selectable options.

17. The system as defined in claim 15 wherein said selectable items include points of interest of selectable sites on said map images.

18. The system as defined in claim 15 wherein said selectable items include events of selectable sites on said map images.

19. The system as defined in claim 15 wherein said selectable items include services available at selectable sites on said map images.
